(19) United States
(12) Patent Application Publication
(10) Pub. No.: US 2024/0253266 A1
(43) Pub. Date: Aug. 1, 2024

(54) METHOD FOR CLEANING PRESS PLATENS USING THERMOSETTING RESIN

(71) Applicant: LOUISIANA-PACIFIC CORPORATION, NASHVILLE, TN (US)

(72) Inventors: JIANWEN NI, FRANKLIN, TN (US); JEFFREY YELLE, HENDERSONVILLE, TN (US); DENNIS LUCAS, SOUTH BOSTON, VA (US)

(21) Appl. No.: 18/429,106

(22) Filed: Jan. 31, 2024

Related U.S. Application Data
(60) Provisional application No. 63/442,135, filed on Jan. 31, 2023.

(51) Int. Cl. B27N 3/20; B27N 3/00; B27N 3/18

(52) U.S. Cl. CPC B27N 3/206; B27N 3/002; B27N 3/18

(57) ABSTRACT

A method and system for removing material build-up, including, but not limited to, boric acid or boric acid-based material, on a press platen. A thermosetting resin is deposited on the upper surface of a manufactured wood chip or strand mat, which is then subjected to heat and pressure in a press. During pressing, the build-up material on the press platen(s) will soften and/or melt, and will adhere to the to thermosetting resin on the top of the mat. After pressing, as the formed panels are removed from the press, the boric acid build-up adhering to the thermosetting resin is pulled off the press platens and is removed with the formed panels. The panels with the buildup may then be processed for appropriate uses or dispositions.

This application claims benefit of and priority to U.S. Prov. App. No. 63/442,135, filed Jan. 31, 2023, which is incorporated herein its entirety by specific reference for all purposes.

### FIELD OF INVENTION

This invention relates to a system and related methods for cleaning boric acid-based fire retardant and other buildup from press platens used in the production of manufactured or engineered wood, including, but not limited to, oriented strand board (OSB).

### BACKGROUND OF INVENTION

In general, wood-based composites include, but are not limited to, oriented strand board (OSB), wafer board, flake board, particleboard, and fiberboard (e.g., medium density fiberboard, or MDF). These wood-based composites are typically formed from a wood element (e.g., flake, strand, particle, wafer) combined with a thermosetting adhesive to bind the wood substrate together. In some processes, other additives are added to impart additional properties to the wood composites. Additives may include, but are not limited to, fire retardants, fungicides, mildewcides, insecticides, and water repellents. A significant advantage of strand and particle-based wood composites is that they have many of the properties of plywood and dimensional lumber, but can be made from a variety of lower grade wood species, smaller trees and waste from other wood product processing. In addition, they can be formed into panels in lengths and widths independent of the size of the harvested timber.

One class of wood-based composite products comprise multilayer, oriented wood strand panel products. These oriented-strand, multilayer composite wood panel products are composed of several layers of thin wood strands, which are wood particles having a length which can be several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on a mat-forming line with the strands of the outer face layers predominantly oriented in a parallel-to-machine direction, and strands in the core layer generally oriented perpendicular to the face layers (i.e., “cross-machine”) direction.

In one known commercial process, these mat layers are bonded together using natural or synthetic adhesive resins under heat and pressure to make the finished product. Oriented, multilayer wood strand panels of the above-described type can be produced with mechanical and physical properties comparable to those of commercial softwood plywood and are used interchangeably, such as for wall and roof sheathing. In certain types of construction, these wood-based panels (and other construction materials) may be required by building codes to meet certain durability requirements, such as fire, wind and water resistance.

Oriented, multilayer wood strand panels and similar products of the above-described type, and examples of processes for pressing and production thereof, are described in detail in U.S. Pat. Nos. 3,164,511, 4,364,984, 5,435,976, 5,470,631, 5,525,394, 5,718,786, 6,461,743, and 11,639,011 (U.S. Pub. No. 20180126584), all of which are incorporated herein in their entireties by specific reference for all purposes.

Some wood panel products (e.g., fire-retardant treated plywood) are treated with fire retardants, which are activated when exposed to heat during a fire event. This reaction converts wood into water and “char” (i.e., partially-burned wood or charcoal), and reduces the susceptibility of the wood to continuous combustion.

While effective for imparting fire retardancy to wood, these fire retardants may be susceptible to premature activation. For example, some fire retardants could be activated under the high heat and high humidity in an attic space during summer, which would degrade the mechanical strength of wood structural panels. Various fire retardant formulations have developed to address this issue. For, example, U.S. Pat. No. 4,373,010 (which is incorporated herein by specific reference for all purposes) describes several liquid fire retardants that contain guanylurea phosphate (GUP) and boric acid. Similarly, U.S. Pat. No. 10,703,009 (which is incorporated herein by specific reference for all purposes) describes an aqueous boric acid dispersion.

Boric acid-based dispersions or solutions are frequently used as a fire-retardant treatment for wood products, including, but not limited to, manufactured or engineered wood products such as OSB. However, boric acid has a melting point of 170.9° C., which is below the typical press temperature for manufacturing OSB and similar products. The melting of the boric acid during pressing results in the buildup of boric acid and other build-up materials (e.g., wood dust, wax, or similar materials) on the press platens. Prior art methods of cleaning such materials from the press platens, such as with a scraper or similar tool, are difficult and inefficient, and often do not result in sufficient removal of the buildup.

### SUMMARY OF INVENTION

The present invention comprises a method and system for using a thermosetting resin to clean boric acid-based fire retardant and other buildup from press platens used in the production of manufactured or engineered wood. The system and method comprises performing one or more cleaning runs through the press to be cleaned. A thermosetting resin, which can be a powder, such as, but not limited to phenol formaldehyde (PF), melamine formaldehyde (MF) or urea formaldehyde (UF), is applied across the top of an oriented strand board (OSB) or manufactured wood strand or chip mat prior to the mat entering the press to be cleaned. The OSB mat is otherwise prepared as known in the prior art (e.g., to produce an OSB board). In a multi-opening press, where multiple mats are pressed simultaneously, each mat is treated with the thermosetting resin on the upper surface of the mat. The mats then enter the press. During the pressing, the build-up of boric acid on the press platens will melt again and stick to the thermosetting resin on the top of the mat, which in turn will cure and bond to the top of the OSB panel formed during the pressing. After pressing, as the panels are removed from the press, the boric acid build-up adhering to the thermosetting resin is pulled off the press platens. The panels with the buildup may then be processed for appropriate uses or dispositions, such as disposal or recycling.

### BRIEF DESCRIPTION OF THE DRAWINGS

FIG. 1 shows a diagram of a method in accordance with the present invention.

FIG. 2 shows a diagram of a spreader mechanism for applying thermosetting resin to the surface of a mat.

### DETAILED DESCRIPTION OF INVENTION

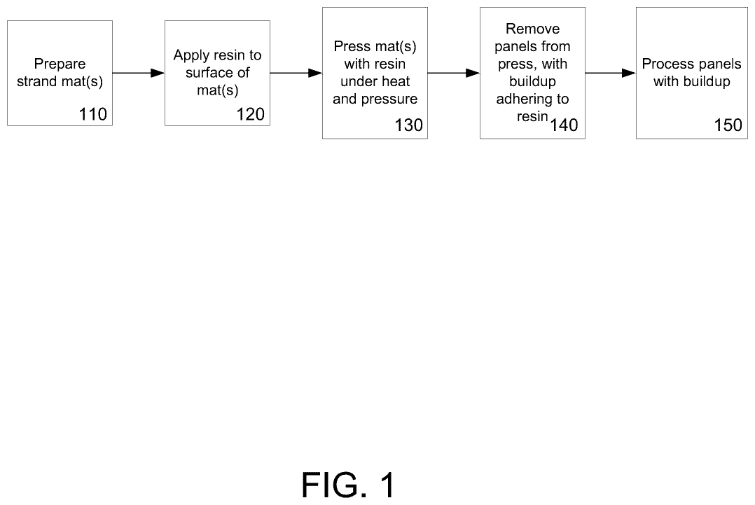

In various exemplary embodiments, as seen in FIG. 1, the present invention comprises a method and system for using a thermosetting resin to clean boric acid-based fire retardant and other buildup from press platens used in the production of manufactured or engineered wood.

In an exemplary embodiment, a system and method of the present invention comprises performing one or more cleaning runs through the press to be cleaned. A thermosetting resin, which can be a powder, such as, but not limited to phenol formaldehyde (PF), melamine formaldehyde (MF) or urea formaldehyde (UF), is applied across the top of an OSB stand or chip mat or other lignocellulosic mat 120 prior to the mat entering the press 130. The OSB mat is otherwise prepared as known in the prior art 110 (e.g., to produce an OSB board).

In a multi-opening press, where multiple mats are pressed simultaneously in a vertical stack, each mat is treated with the thermosetting resin on the upper surface of the mat as described above. As discussed above, the mat layer may comprise multiple layers (e.g., bottom layer, core layer, top layer), each with a mix of strands and/or chips previously blended with adhesives, waxes, and/or additives. While the type of resin used for the thermosetting resin may be the same type as or similar to the adhesive or other material blended with one or more of the layers, in a preferred embodiment the thermosetting resin deposited on the upper surface of the mat is a separate layer from the underlying mat strand layer(s) when the mat enters the press. That is, the thermosetting resin is not previously blended with the mix of strand and/or chips, along with adhesives, waxes, and/or additives, that were used to form the mat or mat layers.

After deposition of the thermosetting resin on the upper surface, the mats then enter the press, each mat directed to an opening. During the pressing under heat and pressure 130, the build-up of boric acid on the press platens will melt again, and because the platens are in contact with the tops of the respective mats, the melted boric acid will stick to the thermosetting resin on the top of the mat, which in turn will cure and bond to the top of the OSB panel formed during the pressing. After pressing, as the panels (which are formed by pressing of the mats) are removed from the press, the boric acid build-up adhering to the thermosetting resin is pulled off the press platens 140 and is removed with the formed OSB panels. The panels with the buildup may then be processed for appropriate uses or dispositions 150, such as, but not limited to, disposal and/or recycling.

This method works similarly in a continuous press, where a single mat is processed at a time. Each mat is treated with the thermosetting resin on the upper surface of the mat as described above, inserted into the press, subjected to pressing under heat and pressure, and then removed with the build-up material (e.g., boric acid) adhering to the thermosetting resin.

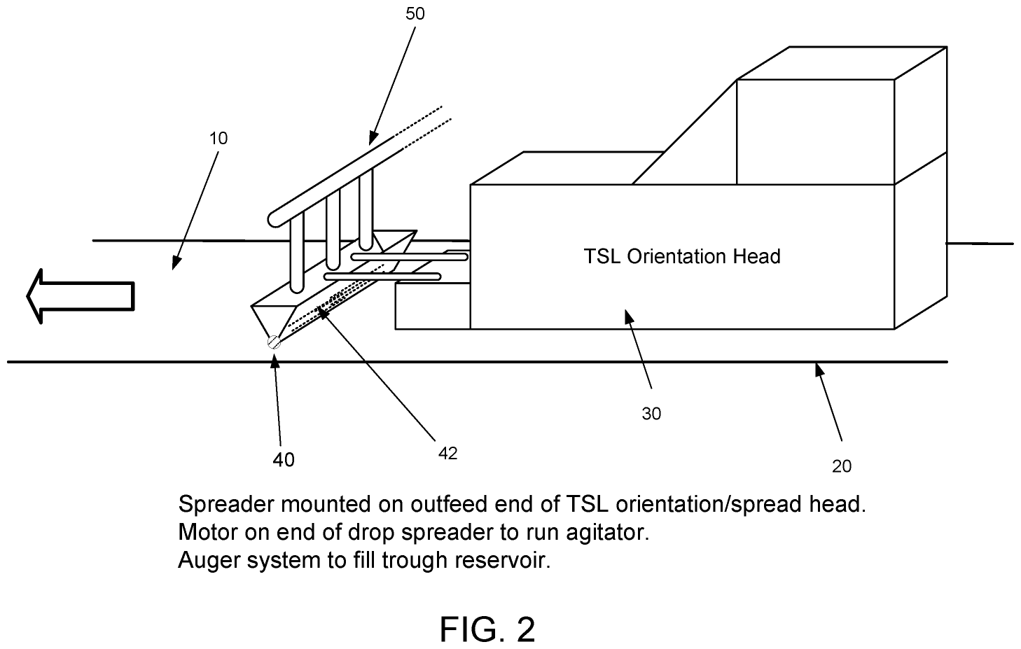

FIG. 2 shows an example of a mechanism for applying the thermosetting resin to one or more mats 10 on a forming line 20. The mat exits the Top Surface Layer (TSL) orientation head 30, as the top layer is the final layer placed on the mat (a fines layer may or may not be applied to the top surface layer). A thermosetting resin spreader 40, comprising a trough or reservoir 42 in the shape of an inverted triangle in cross-section in this embodiment (although other appropriate shapes may be used) extends across the width of the forming line at the outfeed end of the TSL orientation head, and may be mounted on the head itself, or independently mounted. As the formed mat passes underneath, the spreader is agitated (by a motor or other vibration-inducing device) to cause the thermosetting resin to drop on the surface of the mat. The thermosetting resin may be applied in a fairly uniform thickness and/or density across the surface, although the spreader may be set to apply the resin more heavily in some locations of the mat than others, or to apply resin in some locations but not others. An augur system 50, or similar supply system, receives the thermosetting resin, typically in powder form, from a storage bin or tank, and supplies the thermosetting resin (typically in powder form) to the spreader. As shown in FIG. 2, the augur may supply the resin to several locations along the spreader so as to maintain an even level of resin for its length.

Other forms of press buildup can be cleaned and removed from the press platens by this method, including, but not limited to, other fire-retardant materials typically applied to the mat during formation of the OSB panel (or other engineered wood panel).

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for removing material build-up on a press platen, comprising:
forming a manufactured wood strand or chip mat with an upper surface on a forming line;
depositing a thermosetting resin on some or all of the upper surface;
inserting the mat into a press with a platen with material build-up on a first surface of the platen;
pressing the mat under heat and pressure such that the first surface of the platen comes into contact with the thermosetting resin on the upper surface of the mat, whereby at least a portion of the material build-up on the first surface adheres to the thermosetting resin on the upper surface of the mat; and
after pressing, removing the mat with the portion of the material build-up adhering to the thermosetting resin on the upper surface from the mat.

2. The method of claim 1, wherein the manufactured wood strand or chip mat is an oriented strand board mat.

3. The method of claim 1, wherein the press is a multi-opening press.

4. The method of claim 3, wherein the multi-opening press comprises multiple platens and is configured to press multiple mats simultaneously.

5. The method of claim 1, wherein the press is a continuous press.

6. The method of claim 1, wherein the build-up material comprises boric acid or a boric acid-based material.

7. The method of claim 1, wherein the thermosetting resin is a powder.

8. The method of claim 1, wherein the thermosetting resin comprises phenol formaldehyde (PF), melamine formaldehyde (MF), or urea formaldehyde (UF), or combinations thereof.

9. The method of claim 1, wherein the mat layer comprises multiple mat strand and/or chip layers.

10. The method of claim 9, wherein the thermosetting resin is deposited on the upper surface as a separate layer from the underlying mat strand and/or chip layer or layers.

11. The method of claim 1, wherein the step of depositing comprises the step of dropping thermosetting resin on the upper surface as the mat passes under a thermosetting resin spreader.
